(19) United States
(12) Patent Application Publication
(10) Pub. No.: US 2017/0139522 A1
(43) Pub. Date: May 18, 2017

(54) HYBRID IN-CELL TOUCH DISPLAY PANEL

(71) Applicant: Wuhan China Star Optoelectronics Technology Co., Ltd., Wuhan (CN)

(72) Inventor: Qiang Gong, Wuhan (CN)

(21) Appl. No.: 15/000,052

(22) Filed: Jan. 19, 2016

(30) Foreign Application Priority Data
Nov. 18, 2015 (CN) 201510796457.2

(51) Int. Cl. G06F 3/041; G06F 3/047

(52) U.S. Cl. CPC G06F 3/0416; G06F 3/0412; G06F 3/047

(57) ABSTRACT

A hybrid in-cell touch display panel is disclosed. A layout space occupied by transmitter driving units is reduced by halving the number of the transmitter driving units and doubling the number of strip-shaped sensing electrodes, thereby achieving an objective for reducing the size of the left and right borders.

### RELATED APPLICATION

This application claims the benefit of priority of Chinese Patent Application No. 201510796457.2 filed Nov. 18, 2015, the contents of which are incorporated herein by reference in their entirety.

### FIELD AND BACKGROUND OF THE INVENTION

The present invention relates to a field of touch display technology, and more specifically to a hybrid in-cell touch display panel.

Recently, liquid crystal display (LCD) technology has developed rapidly. It has made great progress from the size of the screen to the display quality. LCDs have several characteristics, including small size, low power consumption, and no radiation, which has lead them to dominate the field of flat panel displays.

Liquid crystal display touch screens are one of the major carriers to integrate the input and the output terminal. Recently, with a series of available products of handheld devices which are compact and lightweight, the market demand for liquid crystal display touch screens is surging.

The development directions of the touch technology trend is to reduce cost, increase yield, increase size, increase reliability, etc. In order to achieve these goals, in structure, there are on-cell, in-cell, and hybrid in-cell built-touch structures. In comparison with the in-cell built-touch structure, the hybrid in-cell built-touch structure has the advantages in a better signal-to-noise ratio (SNR), a higher yield rate of panel production, and it can be formed on larger models, and thereby is gradually attracting more attention.

Please refer to FIG. 1, which is a schematic view of an existing hybrid in-cell touch structure 1 in an existing hybrid in-cell touch display panel. The thin film transistor (TFT) array substrate of the existing hybrid in-cell touch display panel includes a touch driving electrode (Tx) pattern layer 10 and a plurality of transmitter driving units 20. A color filter substrate in the existing hybrid in-cell touch display panel has a touch sensing electrode (Rx) pattern layer 30. The touch driving electrode (Tx) pattern layer 10, the transmitter driving units 20, and the touch sensing electrode (Rx) pattern layer 30 construct the existing hybrid in-cell touch structure 1. The touch driving electrode (Tx) pattern layer 10 includes a plurality of strip-shaped driving electrodes 101. The touch sensing electrode (Rx) pattern layer 30 includes a plurality of strip-shaped sensing electrodes 301. The strip-shaped driving electrodes 101 and the strip-shaped sensing electrodes 301 are arranged to each other in a cross manner. Two ends of each of the strip-shaped driving electrodes 101 are electrically connected to a transmitter driving unit 20, respectively. The ends of the strip-shaped sensing electrodes 301 at the same side have a signal line 3011 extending outward, respectively. The overlapping position of each of the strip-shaped driving electrodes 101 and each of the strip-shaped sensing electrodes 301 forms a touch electrode, for example, as shown in the area A of FIG. 1.

As mentioned above, the ends of the left and right sides of each of the strip-shaped driving electrodes 101 in the existing hybrid in-cell touch structure 1 are electrically connected to a transmitter driving unit 20, respectively, thus it can be known that its structure is disadvantageous to a narrow border design for left and right borders. Therefore, there is a need to provide a novel hybrid in-cell touch display panel, so as to overcome the disadvantage in the prior art.

### SUMMARY OF THE INVENTION

An object of the present invention is to provide a hybrid in-cell touch display panel. A layout space occupied by transmitter driving units is reduced by halving the number of the transmitter driving units and doubling the number of strip-shaped sensing electrodes, thereby achieving an objective for reducing the size of left and right borders.

To achieve the above object, the present invention provides a hybrid in-cell touch display panel including a first substrate, a second substrate opposite the first substrate, and a liquid crystal layer sandwiched between the first substrate and the second substrate, in which:
the first substrate includes a touch driving electrode (Tx) pattern layer and a plurality of transmitter driving units, and the touch driving electrode (Tx) pattern layer includes a plurality of strip-shaped driving electrodes;
the second substrate has a touch sensing electrode (Rx) pattern layer, the touch sensing electrode (Rx) pattern layer is divided into a first area and a second area, and
the first area and the second area of the touch sensing electrode (Rx) pattern layer include a plurality of strip-shaped sensing electrodes, respectively; and
the tail ends of each of the strip-shaped driving electrodes corresponding to the first area and each of the strip-shaped driving electrodes corresponding to the second area at the same side are electrically connected to the same transmitter driving unit.

In one exemplary embodiment of the present invention, one end of each of the strip-shaped sensing electrodes in the first area of the touch sensing electrode (Rx) pattern layer and one end of each of the strip-shaped sensing electrodes in the second area of the touch sensing electrode (Rx) pattern layer have a signal line extending outward, respectively.

In one exemplary embodiment of the present invention, the extending direction of the signal line extending outward of each of the strip-shaped sensing electrodes in the first area of the touch sensing electrode (Rx) pattern layer is the same as the extending direction of the signal line extending outward of each of the strip-shaped sensing electrodes in the second area of the touch sensing electrode (Rx) pattern layer.

In one exemplary embodiment of the present invention, the width of each of the strip-shaped sensing electrodes in the first area of the touch sensing electrode (Rx) pattern layer is greater than or less than the width of each of the strip-shaped sensing electrodes in the second area of the touch sensing electrode (Rx) pattern layer.

In one exemplary embodiment of the present invention, the extending direction of the signal line extending outward of each of the strip-shaped sensing electrodes in the first area of the touch sensing electrode (Rx) pattern layer is opposite the extending direction of the signal line extending outward of each of the strip-shaped sensing electrodes in the second area of the touch sensing electrode (Rx) pattern layer.

In one exemplary embodiment of the present invention, each of the strip-shaped sensing electrodes in the first area of the touch sensing electrode (Rx) pattern layer and each of the strip-shaped sensing electrodes in the second area of the touch sensing electrode (Rx) pattern layer are aligned with each other.

In one exemplary embodiment of the present invention, there is a first distance between each of the strip-shaped sensing electrodes in the first area of the touch sensing electrode (Rx) pattern layer and each of the strip-shaped sensing electrodes in the second area of the touch sensing electrode (Rx) pattern layer, there is a second distance between the strip-shaped driving electrodes, and the first distance is less than the second distance.

In one exemplary embodiment of the present invention, the number of the strip-shaped driving electrodes is an even number.

In one exemplary embodiment of the present invention, the strip-shaped driving electrodes and the strip-shaped sensing electrodes are arranged to each other in a cross manner.

In one exemplary embodiment of the present invention, the first substrate is a thin film transistor (TFT) array substrate, and the second substrate is a color filter (CF) substrate.

The present invention has obvious advantages and beneficial effects over the prior art. The hybrid in-cell touch display panel of the present invention according to the above technical scheme has at least the following advantages and beneficial effects. A layout space occupied by the transmitter driving units is reduced by halving the number of the transmitter driving units and doubling the number of the strip-shaped sensing electrodes, thereby achieving an objective for reducing the size of left and right borders.

### BRIEF DESCRIPTION OF THE SEVERAL VIEWS OF THE DRAWINGS

FIG. 1 is a schematic view of an existing hybrid in-cell touch structure in an existing hybrid in-cell touch display panel;

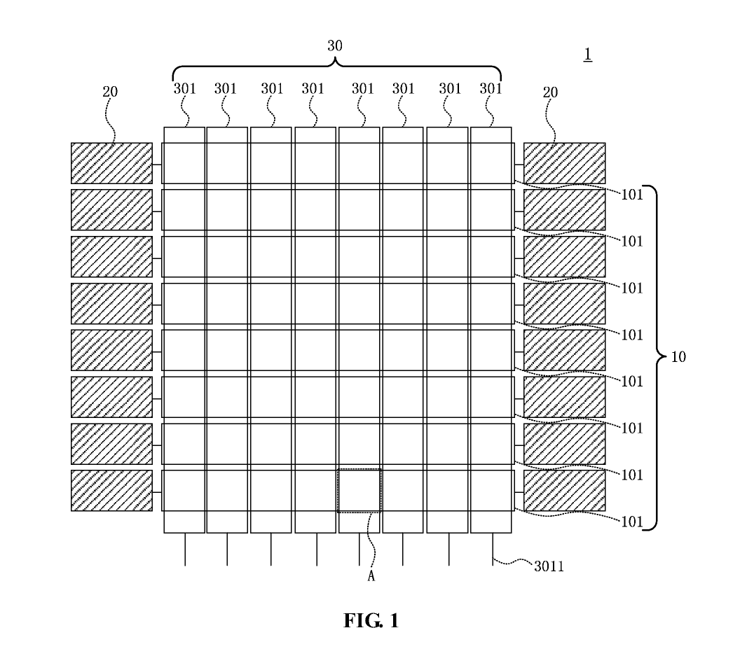

FIG. 2 is a schematic view of a hybrid in-cell touch structure in a hybrid in-cell touch display panel according to a first embodiment of the present invention;

FIG. 3 is an enlarged view of an area B in FIG. 2; and

FIG. 4 is a schematic view of a hybrid in-cell touch structure in a hybrid in-cell touch display panel according to a second embodiment of the present invention.

### DESCRIPTION OF SPECIFIC EMBODIMENTS OF THE INVENTION

Various preferred embodiments are now described with reference to the accompanying drawings. In the following description, for purposes of explanation, numerous specific details are set forth in order to provide a thorough understanding of a hybrid in-cell touch display panel, and its specific embodiment, structure, feature and functions.

The hybrid in-cell touch display panel of the present invention includes a first substrate, a second substrate, and a liquid crystal layer (these features belong to prior art and thus are not shown in the figures). The second substrate and the first substrate are correspondingly arranged and opposite each other. The liquid crystal layer is sandwiched between the first substrate and the second substrate. The first substrate can be a thin film transistor (TFT) array substrate. The second substrate can be a color filter (CF) substrate.

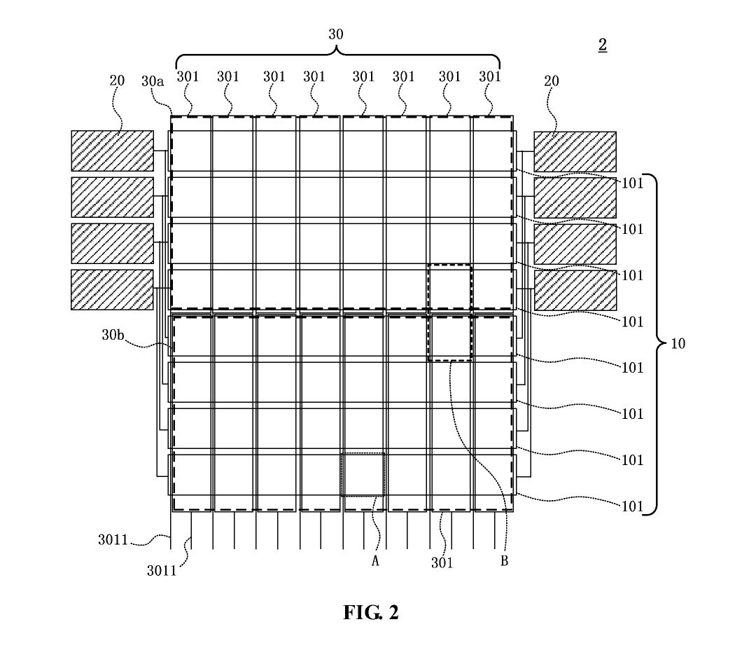

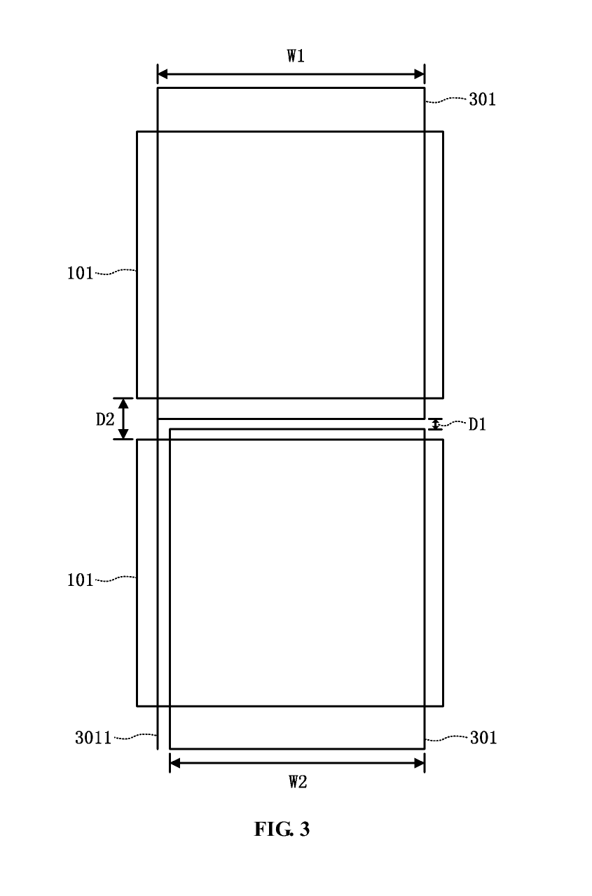

Please refer to FIG. 2 and FIG. 3. FIG. 2 is a schematic view of a hybrid in-cell touch structure 2 in a hybrid in-cell touch display panel according to a first embodiment of the present invention. FIG. 3 is an enlarged view of an area B in FIG. 2. The first substrate of the hybrid in-cell touch display panel includes a touch driving electrode (Tx) pattern layer 10 and a plurality of transmitter driving units 20. The second substrate in the hybrid in-cell touch display panel has a touch sensing electrode (Rx) pattern layer 30. The touch driving electrode (Tx) pattern layer 10, the transmitter driving units 20, and the touch sensing electrode (Rx) pattern layer 30 construct the hybrid in-cell touch structure 2.

The touch driving electrode (Tx) pattern layer 10 includes a plurality of strip-shaped driving electrodes 101. The number of the strip-shaped driving electrodes 101 is an even number. The touch sensing electrode (Rx) pattern layer 30 is divided into a first area 30a and a second area 30b. The first area 30a and the second area 30b of the touch sensing electrode (Rx) pattern layer 30 include a plurality of strip-shaped sensing electrodes 301, respectively. Each of the strip-shaped sensing electrodes 301 in the first area 30a of the touch sensing electrode (Rx) pattern layer 30 and each of the strip-shaped sensing electrodes 301 in the second area 30b of the touch sensing electrode (Rx) pattern layer 30 are aligned with each other. There is a first distance D1 between each of the strip-shaped sensing electrodes 301 in the first area 30a of the touch sensing electrode (Rx) pattern layer 30 and each of the strip-shaped sensing electrodes 301 in the second area 30b of the touch sensing electrode (Rx) pattern layer 30. There is a second distance D2 between the strip-shaped driving electrodes 101. The first distance D1 is less than the second distance D2. The strip-shaped driving electrodes 101 and the strip-shaped sensing electrodes 301 are arranged to each other in a cross manner.

The tail ends of each of the strip-shaped driving electrodes 101 corresponding to the first area 30a and each of the strip-shaped driving electrodes 101 corresponding to the second area 30b at the same side are electrically connected to the same transmitter driving unit 20. That is, the present embodiment is that the ends of the left sides of a first strip-shaped driving electrode 101 and a fifth strip-shaped driving electrode 101 from top to bottom are electrically connected to a first transmitter driving unit 20 from top to bottom at left side, and the ends of their right sides are electrically connected to a first transmitter driving unit 20 from top to bottom at right side.

One end of each of the strip-shaped sensing electrodes 301 in the first area 30a of the touch sensing electrode (Rx) pattern layer 30 and one end of each of the strip-shaped sensing electrodes 301 in the second area 30b of the touch sensing electrode (Rx) pattern layer 30 have a signal line 3011 extending outward, respectively. The extending direction of the signal line 3011 extending outward of each of the strip-shaped sensing electrodes 301 in the first area 30a of the touch sensing electrode (Rx) pattern layer 30 is the same as the extending direction of the signal line 3011 extending outward of each of the strip-shaped sensing electrodes 301 in the second area 30b of the touch sensing electrode (Rx) pattern layer 30. The width W1 of each of the strip-shaped sensing electrodes 301 in the first area 30a of the touch sensing electrode (Rx) pattern layer 30 is greater than the width W2 of each of the strip-shaped sensing electrodes 301 in the second area 30b of the touch sensing electrode (Rx) pattern layer 30, thus the signal line 3011 extending outward of each of the strip-shaped sensing electrodes 301 in the first area 30a of the touch sensing electrode (Rx) pattern layer 30 can be led out. The signal lines 3011 extending outward are electrically connected to one end of a FPC (not shown in the figure). The overlapping position of each of the strip-shaped driving electrodes 101 and each of the strip-shaped sensing electrodes 301 forms a touch electrode, for example, as shown in the area A of FIG. 2. When the transmitter driving signal of the touch driving electrode (Tx) pattern layer 10 is progressively scanned, a touch potential is identified by detecting the signal changes of each of the strip-shaped sensing electrodes 301.

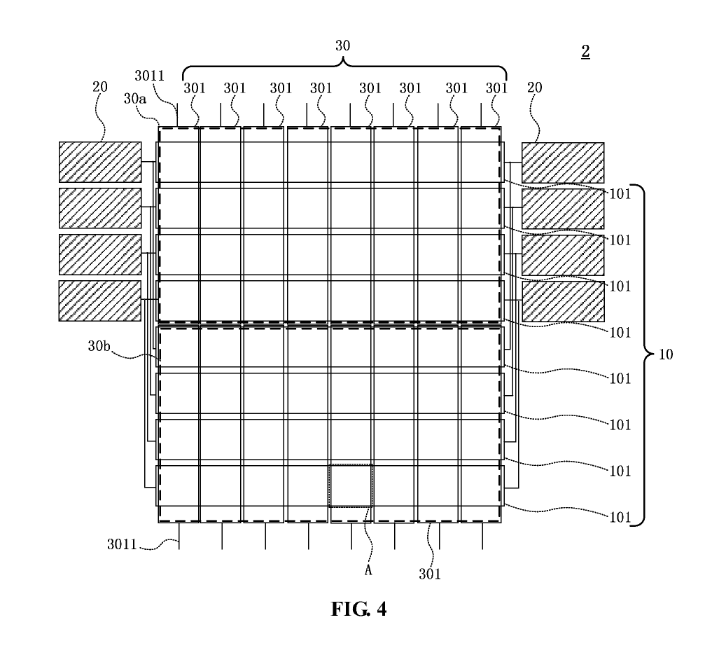

Please refer to FIG. 4, which is a schematic view of a hybrid in-cell touch structure 2 in a hybrid in-cell touch display panel according to a second embodiment of the present invention. The second embodiment of the hybrid in-cell touch structure 2 in the hybrid in-cell touch display panel according the present invention is similar to the first embodiment. The second embodiment and the first embodiment are different in that: The width of each of the strip-shaped sensing electrodes 301 in the first area 30a of the touch sensing electrode (Rx) pattern layer 30 is equal to the width of each of the strip-shaped sensing electrodes 301 in the second area 30b of the touch sensing electrode (Rx) pattern layer 30; and the extending direction of the signal line 3011 extending outward of each of the strip-shaped sensing electrodes 301 in the first area 30a of the touch sensing electrode (Rx) pattern layer 30 is opposite the extending direction of the signal line 3011 extending outward of each of the strip-shaped sensing electrodes 301 in the second area 30b of the touch sensing electrode (Rx) pattern layer 30.

As mentioned above, in the hybrid in-cell touch display panel of the present invention, a layout space occupied by the transmitter driving units 20 is reduced by halving the number of the transmitter driving units 20 and doubling the number of the strip-shaped sensing electrodes 301, thereby achieving an objective for reducing the size of left and right borders.

The above description of the invention is intended to be illustrative and not limiting. Various changes or modifications in the embodiments described may occur to those skilled in the art. These can be achieved without departing from the spirit or scope of the invention.

What is claimed is:

1. A hybrid in-cell touch display panel, comprising:
a first substrate;
a second substrate opposite the first substrate; and
a liquid crystal layer sandwiched between the first substrate and the second substrate,
wherein:
the first substrate comprises a touch driving electrode (Tx) pattern layer and a plurality of transmitter driving units, and the touch driving electrode (Tx) pattern layer comprises a plurality of strip-shaped driving electrodes;
the second substrate has a touch sensing electrode (Rx) pattern layer, the touch sensing electrode (Rx) pattern layer is divided into a first area and a second area, and the first area and the second area of the touch sensing electrode (Rx) pattern layer comprise a plurality of strip-shaped sensing electrodes, respectively; and
tail ends of each of the strip-shaped driving electrodes corresponding to the first area and each of the strip-shaped driving electrodes corresponding to the second area at the same side are electrically connected to the same transmitter driving unit.

2. The hybrid in-cell touch display panel of claim 1, wherein one end of each of the strip-shaped sensing electrodes in the first area of the touch sensing electrode (Rx) pattern layer and one end of each of the strip-shaped sensing electrodes in the second area of the touch sensing electrode (Rx) pattern layer have a signal line extending outward, respectively.

3. The hybrid in-cell touch display panel of claim 2, wherein an extending direction of the signal line extending outward of each of the strip-shaped sensing electrodes in the first area of the touch sensing electrode (Rx) pattern layer is the same as an extending direction of the signal line extending outward of each of the strip-shaped sensing electrodes in the second area of the touch sensing electrode (Rx) pattern layer.

4. The hybrid in-cell touch display panel of claim 3, wherein a width of each of the strip-shaped sensing electrodes in the first area of the touch sensing electrode (Rx) pattern layer is greater than or less than a width of each of the strip-shaped sensing electrodes in the second area of the touch sensing electrode (Rx) pattern layer.

5. The hybrid in-cell touch display panel of claim 2, wherein an extending direction of the signal line extending outward of each of the strip-shaped sensing electrodes in the first area of the touch sensing electrode (Rx) pattern layer is opposite an extending direction of the signal line extending outward of each of the strip-shaped sensing electrodes in the second area of the touch sensing electrode (Rx) pattern layer.

6. The hybrid in-cell touch display panel of claim 1, wherein each of the strip-shaped sensing electrodes in the first area of the touch sensing electrode (Rx) pattern layer and each of the strip-shaped sensing electrodes in the second area of the touch sensing electrode (Rx) pattern layer are aligned with each other.

7. The hybrid in-cell touch display panel of claim 6, wherein there is a first distance between each of the strip-shaped sensing electrodes in the first area of the touch sensing electrode (Rx) pattern layer and each of the strip-shaped sensing electrodes in the second area of the touch sensing electrode (Rx) pattern layer, there is a second distance between the strip-shaped driving electrodes, and the first distance is less than the second distance.

8. The hybrid in-cell touch display panel of claim 1, wherein a number of the strip-shaped driving electrodes is an even number.

9. The hybrid in-cell touch display panel of claim 1, wherein the strip-shaped driving electrodes and the strip-shaped sensing electrodes are arranged to each other in a cross manner.

10. The hybrid in-cell touch display panel of claim 1, wherein the first substrate is a thin film transistor array substrate, and the second substrate is a color filter substrate.
